(19) United States
(12) Patent Application Publication
(10) Pub. No.: US 2013/0299397 A1
(43) Pub. Date: Nov. 14, 2013

(54) Spiral Separator and Method Therefor

(71) Applicants: Steve Eugene DeJong, Maple Grove, MN (US); Dennis DeJong, Maple Grove, MN (US); Chad Culbertson, Zimmerman, MN (US)

(72) Inventors: Steve Eugene DeJong, Maple Grove, MN (US); Dennis DeJong, Maple Grove, MN (US); Chad Culbertson, Zimmerman, MN (US)

(21) Appl. No.: 13/468,877

(22) Filed: May 10, 2012

(51) Int. Cl. B07B 13/00

(52) U.S. Cl. CPC B07B 13/003
USPC 209/606

(57) ABSTRACT

A spiral separator apparatus is used to separate a mixture of particles of different shapes. The spiral separator apparatus includes a rotating separator core that has a number of banked flights. As the separator core rotates, non-round particles continue traveling down the banked flights, while round or substantially round particles are ejected from the separator core by centrifugal force. Particles that are ejected from the separator core impact a housing, fall, and are collected, for example, in a collection bin.

### TECHNICAL FIELD

This disclosure relates generally to industrial and agricultural machinery. More particularly, the disclosure relates to spiral separators.

### BACKGROUND

Spiral separators are used to sort particulate material, such as seeds, metal shot, and glass or ceramic media from other media in which they are present. A spiral separator generally includes a number of flights that are spirally wound around a central axis. Some particles, such as seeds or shot that are spherical or substantially spherical, travel faster than other particles and are flung off the flights and are collected in a receptacle, such as a bin. Non-round particles travel more slowly and are not flung off the flights, but are instead collected at the bottom of the spiral separator.

Some conventional spiral separators are adversely affected by certain drawbacks. For instance, because the rate of incline in the spiral flights and the banking angle of the flights are generally predetermined by the manufacturer, some conventional spiral separators are relatively inflexible in adjusting the separation of material for roundness and yield. They also lack adjustability for separating the same type of material when the material size and weight may be different between different batches.

### SUMMARY OF THE DISCLOSURE

According to various example embodiments, a spiral separator apparatus is used to separate a mixture of particles of different shapes. The spiral separator apparatus includes a rotating separator core that has a number of banked flights. As the separator core rotates, non-round particles continue traveling down the banked flights, while round or substantially round particles are ejected from the separator core by centrifugal force. Particles that are ejected from the separator core impact a housing, fall, and are collected, for example, in a collection bin.

One embodiment is directed to a spiral separator apparatus comprising a motor and a hollow shaft coupled to the motor. A separator core is coupled to the hollow shaft and arranged to rotate when the motor is energized. The separator core includes a plurality of banked flights spirally disposed around an axis coincident with an axis of the hollow shaft. A feed portion is located proximate a top end portion of the separator core and is arranged to receive a mixture of substantially round particles and non-round particles. A housing substantially surrounding the separator core is arranged to be impacted by substantially round particles cast from the separator core when the separator core rotates.

Another embodiment is directed to a spiral separator apparatus comprising a motor, a control module configured to control a rotational speed of the motor, and a hollow shaft. Drive means are coupled between the motor and the hollow shaft. A separator core is coupled to the hollow shaft and is arranged to rotate when the motor is energized. The separator core comprising a plurality of banked flights spirally disposed around an axis coincident with an axis of the hollow shaft. A feed portion is proximate a top end portion of the separator core and is arranged to receive a mixture of substantially round particles and non-round particles.

Still another embodiment is directed to a method of separating a plurality of substantially round particles from a mixture of the substantially round particles and a plurality of non-round particles. A motor is energized to cause a separator core of a spiral separator apparatus to rotate about an axis. The separator core includes a plurality of banked flights spirally disposed around a hollow shaft. The mixture of substantially round particles and non-round particles is passed through a feed portion of the separator apparatus and to the banked flights. The substantially round particles are ejected from the banked flights and impact a housing substantially surrounding the separator core when the separator core rotates. The substantially round particles are collected after the substantially round particles impact the housing.

The disclosed embodiments may realize certain advantages. For instance, the housing may prevent substantial ingress or egress of contaminants and leakage of round particles and may mitigate noise. It can be pressurized or filled with gasses for processing combustible materials. Further, the apparatus can be dismantled for transporting and moving into tight quarters. The use of a housing also facilitates the use of more flights as compared with conventional designs, allowing for higher processing capacity. The apparatus is compact and can be packed relatively tightly compared with conventional spiral separators. Perhaps most importantly, the use of a housing promotes safety by substantially reducing the risk that an operator will be injured by the rotating spiral separator.

### BRIEF DESCRIPTION OF THE DRAWINGS

FIG. 1 illustrates an exploded view of an example spiral separator apparatus according to an embodiment.

FIG. 2 illustrates plan views of portions of a housing of the spiral separator apparatus of FIG. 1.

FIG. 3 illustrates a plan view of a feed module of the spiral separator apparatus of FIG. 1.

FIG. 4 illustrates a plan view of a drive portion of a spiral separator apparatus with a belt drive mechanism according to another embodiment.

FIG. 5 illustrates a side view of the spiral separator apparatus of FIG. 1 with the belt drive mechanism of FIG. 4.

FIG. 6 illustrates a sectional view of the spiral separator of FIG. 1, taken across line T-T of FIG. 5.

FIG. 7 illustrates a schematic view of a control arrangement of the spiral separator apparatus of FIG. 1.

### DETAILED DESCRIPTION

The inventive subject matter is described with specificity to meet statutory requirements. However, the description itself is not intended to limit the scope of this patent. Rather, it is contemplated that the claimed subject matter might also be embodied in other ways, to include different steps or combinations of steps similar to the ones described in this document, in conjunction with other present or future technologies.

According to various disclosed embodiments, a spiral separator apparatus is used to separate a mixture of particles of different shapes. The shape separator apparatus includes a rotating separator core that has a number of banked flights. As the separator core rotates, non-round particles continue traveling down the banked flights, while round or substantially round particles are ejected from the separator core by centrifugal force. Particles that are ejected from the separator core impact a housing, fall, and are collected, for example, in a collection bin.

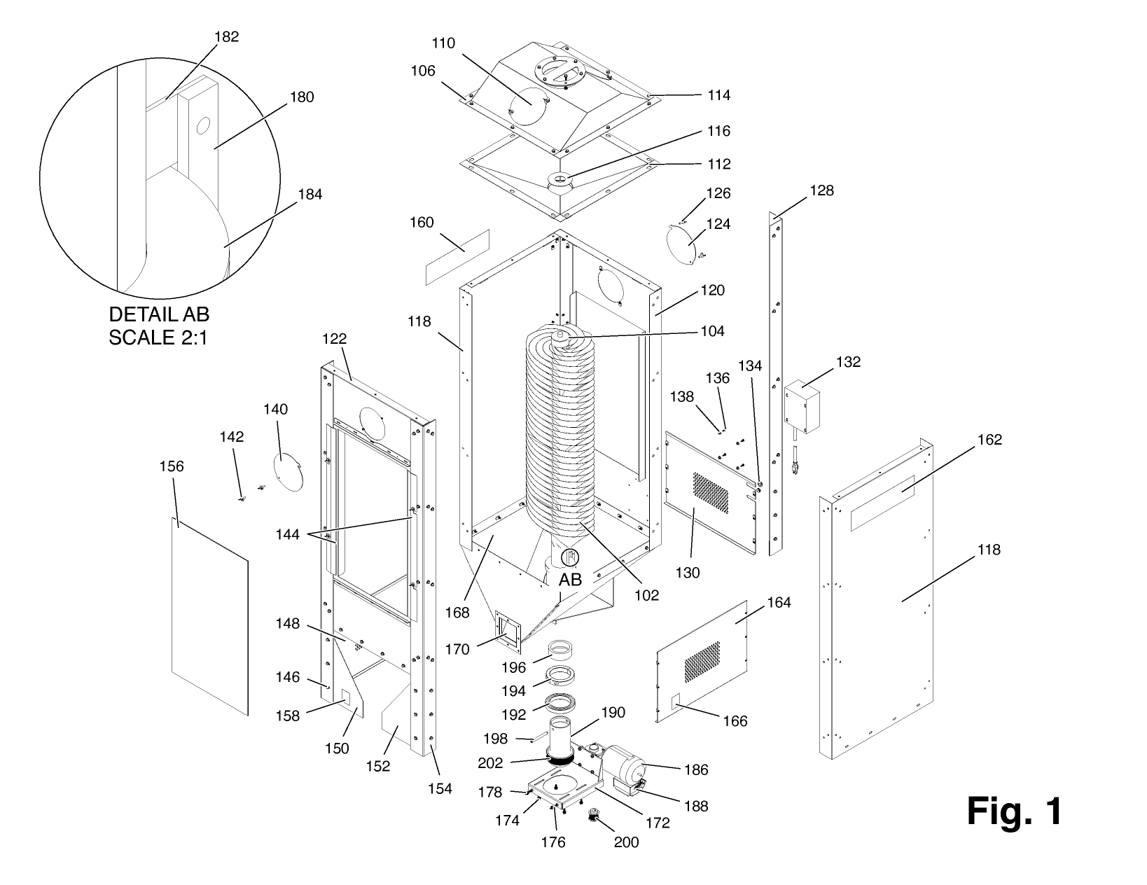

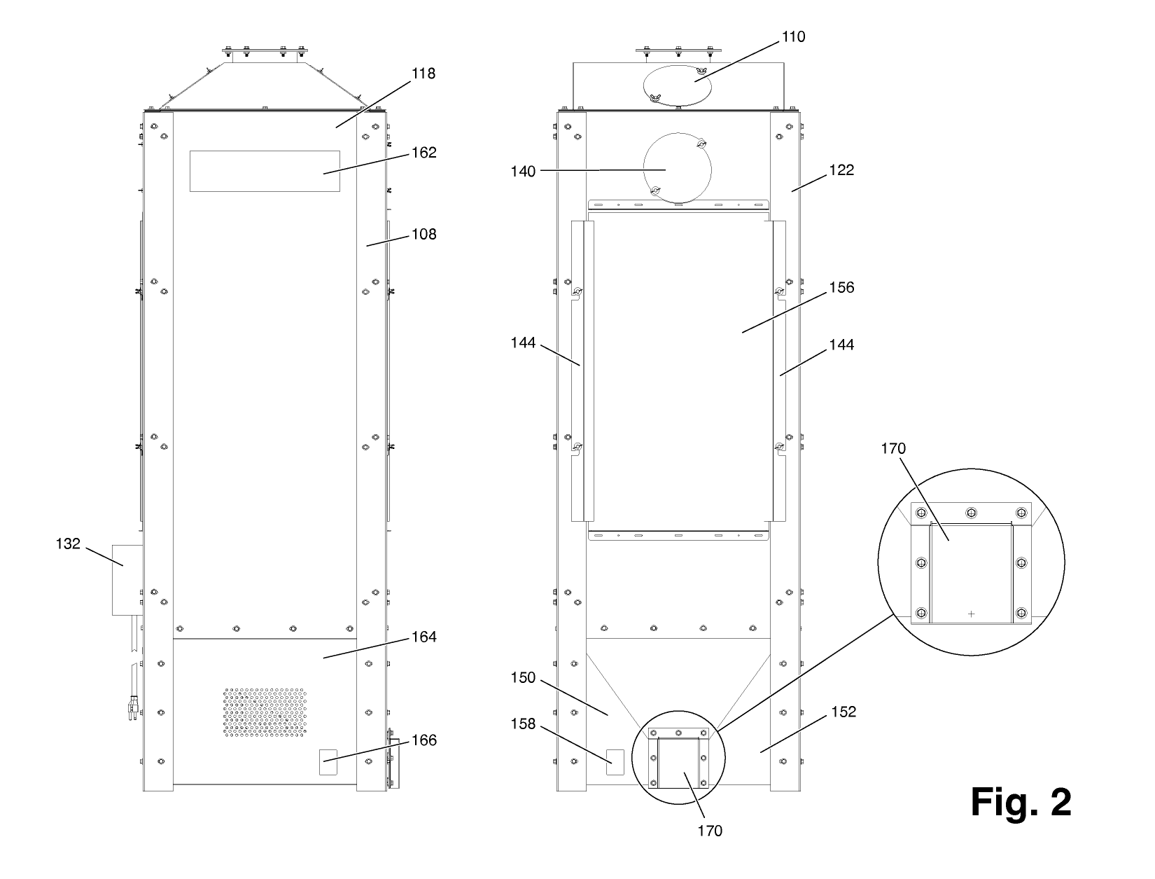

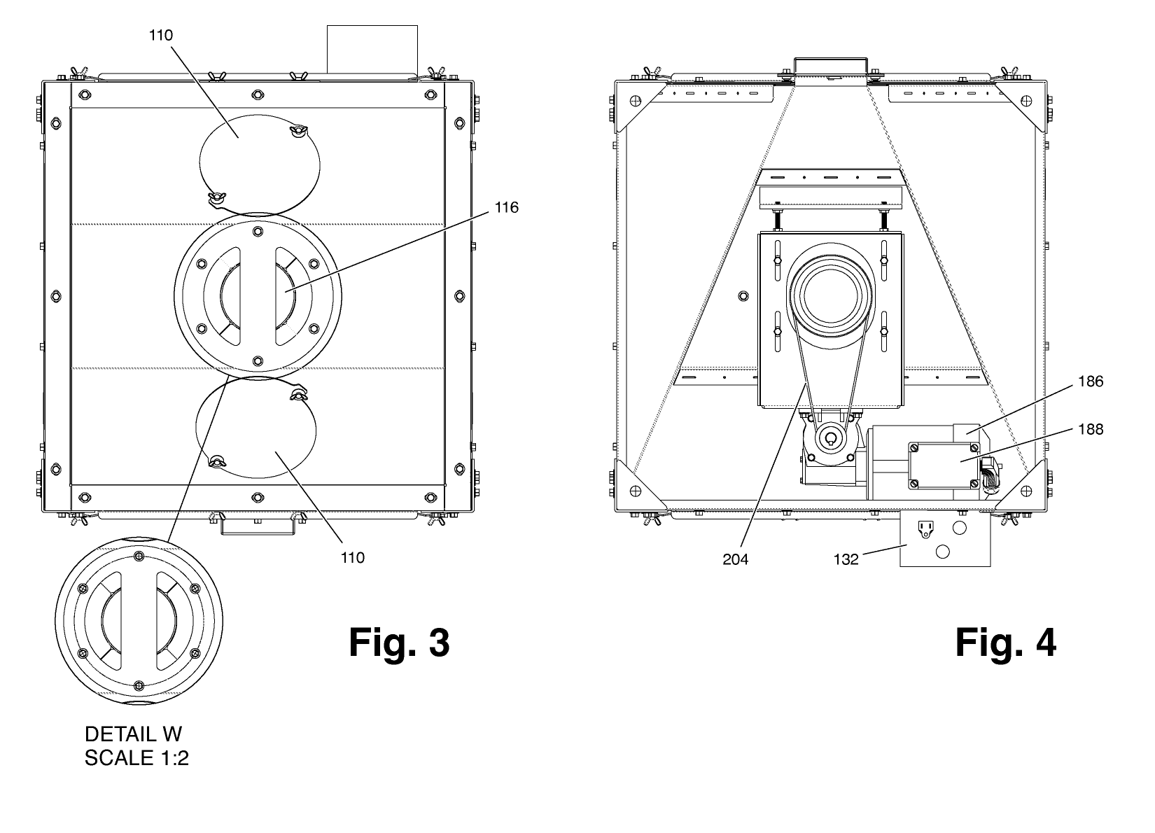

Referring now to the drawings, FIG. 1 illustrates an exploded view of a spiral separator apparatus 100 according to an example embodiment. FIGS. 2-3 show side and top views of the spiral separator apparatus 100. A separator core 102 having a number of banked flights is spirally wound around an axis that is coincident with an axis of a hollow bearing shaft 104. The separator core 102 may be formed from any of a variety of materials suitable for the particular application, such as, for example, steel, galvanized steel, stainless steel, composite, casted material, or a combination of such materials. Unlike some conventional separator cores, the separator core 102 disclosed herein is modular in that it can be removed from the spiral separator apparatus and exchanged for a different separator core 102, such as a separator core 102 formed from a different material.

In the example embodiment illustrated in FIG. 1, the separator core 102 has eight flights. It will be appreciated by those of ordinary skill in the art that the separator core 102 may have more or fewer flights. The use of eight flights is advantageous relative to other designs that employ, for example, four flights in that a separator using eight flights can realize approximately 70% greater capacity as compared with a separator using four flights.

The top portion of the separator core 102 is located near a feed module 106 of the spiral separator apparatus 100. A top plan view of the feed module 106 is depicted in FIG. 3. The feed module 106 includes a door assembly 108 including access doors 110 and an interior assembly 112 attached to one another, for example, using screws 114. An orifice plate 116 covers an orifice at the bottom of the feed module 106. Material to be sorted or separated enters the spiral separator apparatus 100 through an orifice at the top of the feed module 106 and travels to the separator core 102 through the orifice at the bottom of the feed module 106. In some embodiments, the feed module 106 may be configured to meter or distribute the material substantially evenly among the various flights of the separator core 102. As a particular example, a dispersion cone may be employed to distribute the material substantially evenly among the flights.

Once in the separator core 102, the material travels down the flights. As the material travels down the banked surface of the flights, its speed increases, and centrifugal force carries the material toward the outer edge of the flights. Spherical or nearly spherical matter travels faster and achieves a velocity sufficient to carry it over the outer edge of the flights. Non-spherical and less dense matter fail to achieve this velocity and do not reach the edge, but rather continue to travel downward and ultimately exit separately at the bottom through the hollow bearing shaft 104.

In contrast to some conventional spiral separators, the embodiment illustrated in FIG. 1 does not have an outer flight to catch round particles that are flung off inner flights. Instead, a housing catches the matter that is flung from the flights in this way and discharges it through a discharge chute at the bottom of the housing. The use of a housing allows the outer flight to be omitted, thereby allowing the overall design of the spiral separator apparatus 100 to be more compact relative to conventional designs that use an outer flight. In addition, the housing enhances safety and improves efficiency by reducing or eliminating the number of particles that are flung off the spiral separator apparatus 100 as compared with conventional designs that lack a housing. Noise is reduced. Further, the housing acts as a barrier against ingress or egress of dust or contaminants. The housing also acts as a barrier that prevents the rotating separator core 102 from injuring the operator. In some applications, the housing can be filled or pressurized with specific gasses for processing combustible materials.

The housing is formed by side panels 118 and side assemblies 120, 122 and is formed from any of a variety of materials suitable for the particular application or environment, such as, for example, steel, galvanized steel, stainless steel, plastic, composite or casted material, or any combination of the above materials. The side assembly 120 includes an access door 124 attached to the side assembly 120 by a screw 126, a rotary leg assembly 128, a lower panel assembly 130, a motor controller 132, and a grommet 134. The lower panel assembly may be attached to the side assembly 120 by screws 136 and nuts 138, for example. The side assembly 122 includes an access door 140 attached to the side assembly 122 by a screw 142, window brackets 144 attached by screws 146, a sloped lower panel assembly 148, panels 150, 152, and a rotary leg assembly 154. A door assembly 156 provides access to the separator core 102. A label 158 may convey warning or other information. Side panels 118 may also include labels 160, 162 that convey branding or other information. A lower panel assembly 164 may also include a label 166 that conveys warning or other information. The housing may include one or more mats 168 to reduce noise produced when material impacts the bottom of the housing.

At the bottom of the housing, a discharge chute 170 defined proximate the side assembly 122 allows round matter to exit the spiral separator apparatus 100 and to be collected by a first discharge bin (not shown). Non-round matter, on the other hand, travels to the bottom of the separator core 102, where it enters the hollow bearing shaft 104 and falls through an orifice formed in a motor bracket mount 172 and is collected, for example, in a second discharge bin (not shown). The motor bracket mount 172 is attached to the housing via screws 174, 176 and a flange nut 178. A rubber brush 180, shown in the inset of FIG. 1 and attached to the hollow bearing shaft 104 via a brush plate bracket 182 proximate a core shield 184, rotates with the hollow bearing shaft 104 and works to prevent non-round matter from escaping through the discharge chute 170.

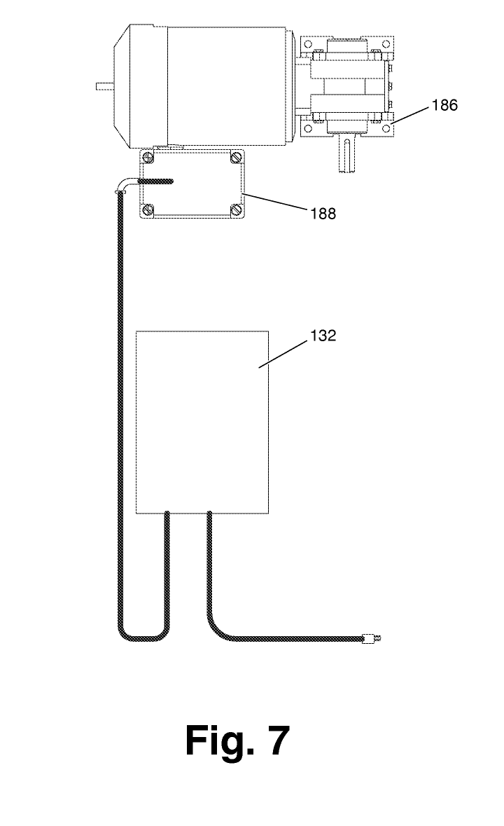

In contrast to some conventional spiral separators, the spiral separator apparatus 100 disclosed herein is not strictly gravity-fed. In particular, the separator core 102 is driven by a motor 186 to rotate when the motor is energized. The motor 186 is connected to the motor controller 132 through a terminal box 188. FIG. 7 depicts this arrangement. The motor 186 is connected to the bearing shaft 104 via a coupling sleeve 190, a bearing 192, a split shaft collar 194, and an upper bearing 196, which are pinned together by a roll pin 198. In the embodiment shown in FIG. 1, the motor 186 drives a gear, e.g., a 24-tooth gear 200, which in turn drives a gear, e.g., a 72-tooth gear 202, located proximate the bottom of the coupling sleeve 190. As a result, the coupling sleeve 190 rotates, causing the bearing shaft 104 and separator core 102 to rotate.

The rotational speed and direction of the motor 186 and, thus, of the separator core 102, can be controlled by the motor controller 132. The ability to control the rotational speed and direction of the motor 186 may offer a number of advantages as compared with static spiral separators, which rely on gravity and are not motor-driven. For instance, adjusting the speed and direction of the rotation of the separator core 102 facilitates fine-tuning of the spiral separator apparatus 100 to separate materials of different types, such as metal shot, glass beads, ceramic beads, and metal powders, and sizes. This feature addresses the need in the seed industry to be able to separate varying sizes of the same type of seed, which conventional static separators do not separate well. Further, in the industrial market, e.g., classifying metal shot, glass beads, and ceramic beads by shape, a higher yield of rounds can be achieved relative to static separators. As another benefit, this design can separate fine particle industrial media and powder metals much faster than conventional separators that use a vibrating angled plate.

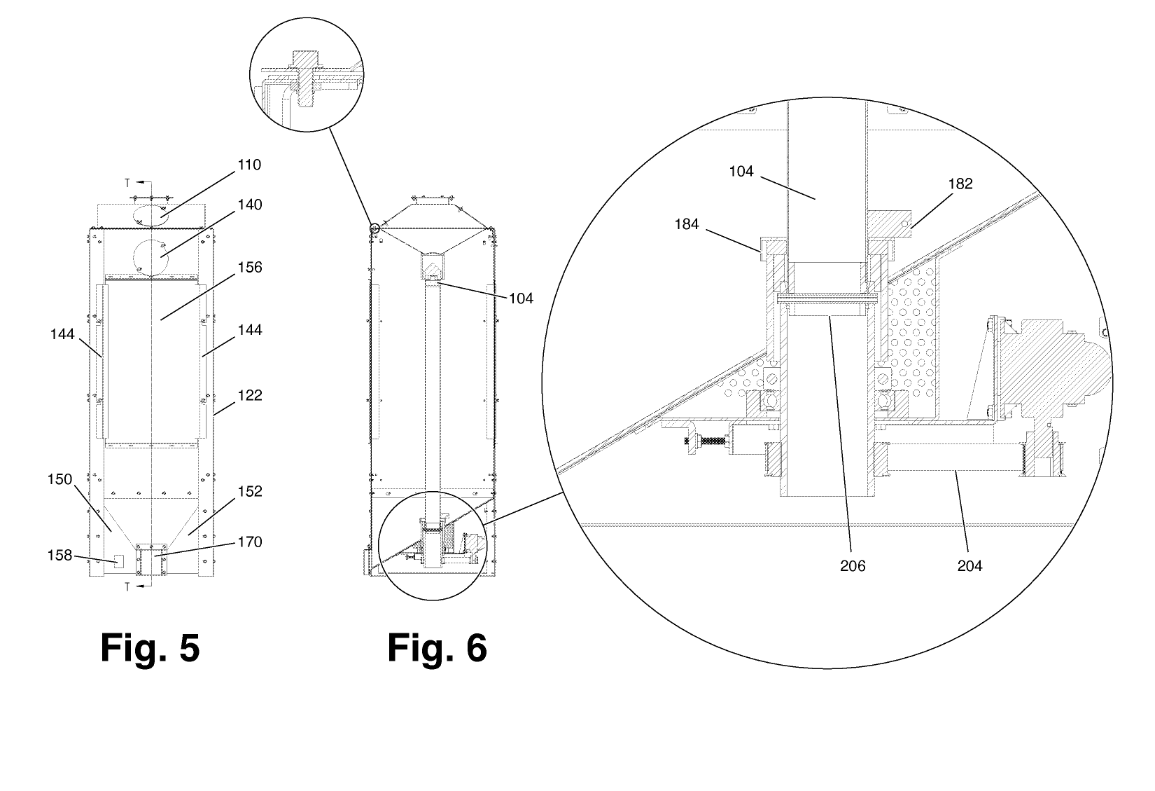

FIG. 1 depicts a spiral separator apparatus 100 with a gear drive mechanism. It will be appreciated that other embodiments may use different drive mechanisms, such as a belt drive, a screw drive, or a chain drive. As a particular non-limiting example, FIG. 4 illustrates a plan view of a drive portion of another embodiment of the spiral separator apparatus 100 with a belt drive mechanism instead of the gear drive mechanism shown in FIG. 1. The belt drive mechanism may include a similar motor 186 and terminal box 188 as shown in FIG. 1. Further, as shown in FIG. 4 and FIG. 6, which is a sectional view taken across section line T-T of FIG. 5, the belt drive mechanism may include a belt 204 and a tube insert 206 that couples the motor 186 to the bearing shaft 104.

As another non-limiting example, the drive portion could be implemented using a direct drive, such as an STH-Series hollow output rotary actuator, available from Nidec-Shimpo America Corporation of Itasca, Ill.

As demonstrated by the foregoing discussion, various embodiments may provide certain advantages. The use of a housing, in particular, may realize a number of benefits. The housing may prevent substantial ingress or egress of contaminants and leakage of round particles and may mitigate noise. It can be pressurized or filled with gasses for processing combustible materials. Further, it is designed to be dismantled for transporting and moving into tight quarters, such as elevators and small openings. The use of a housing also facilitates the use of more flights as compared with conventional designs, allowing for higher processing capacity. It is compact; as a result, it may be possible to pack multiple spiral separator apparatuses more tightly than conventional spiral separators. Perhaps most importantly, the use of a housing promotes safety by substantially reducing the risk that an operator will be injured by the rotating spiral separator.

Using a rotating separator core may also provide certain advantages. The separator core can be rotated at different speeds and different directions to sort different types of materials, such as seed, metal shot, glass particles, and ceramic particles, and electronic components such as resistors. Further, by disengaging the coupling sleeve 190, the operator can remove the separator core for maintenance or for swapping out with another type of separator core, for example, formed from a different material. As a particular example, a steel separator core could be swapped out for a separator core formed from galvanized steel, stainless steel, plastic, composite, or casted material, or a combination of such materials. These features make the spiral separator apparatus 100 disclosed herein more versatile than some conventional designs and suitable for a wide variety of applications.

It will be understood by those who practice the embodiments described herein and those skilled in the art that various modifications and improvements may be made without departing from the spirit and scope of the disclosed embodiments. The scope of protection afforded is to be determined solely by the claims and by the breadth of interpretation allowed by law.

What is claimed is:

1. A spiral separator apparatus comprising:
a motor;
a hollow shaft coupled to the motor;
a separator core coupled to the hollow shaft and arranged to rotate when the motor is energized, the separator core comprising a plurality of banked flights spirally disposed around an axis coincident with an axis of the hollow shaft;
a feed portion proximate a top end portion of the separator core and arranged to receive a mixture of substantially round particles and non-round particles; and
a housing substantially surrounding the separator core and arranged to be impacted by substantially round particles cast from the separator core when the separator core rotates.

2. The spiral separator apparatus of claim 1, further comprising a control module configured to control a rotational speed of the separator core.

3. The spiral separator apparatus of claim 2, wherein the control module is further configured to control a rotational direction of the separator core.

4. The spiral separator apparatus of claim 1, further comprising drive means operably connected to the motor and to the hollow shaft.

5. The spiral separator apparatus of claim 1, the drive means comprising a belt drive.

6. The spiral separator apparatus of claim 1, the drive means comprising a direct drive.

7. The spiral separator apparatus of claim 1, wherein the feed portion is arranged to distribute the mixture of substantially round particles and non-round particles substantially evenly among the flights of the separator core.

8. A spiral separator apparatus comprising:
a motor;
a control module configured to control a rotational speed of the motor;
a hollow shaft;
drive means coupled between the motor and the hollow shaft;
a separator core coupled to the hollow shaft and arranged to rotate when the motor is energized, the separator core comprising a plurality of banked flights spirally disposed around an axis coincident with an axis of the hollow shaft; and
a feed portion proximate a top end portion of the separator core and arranged to receive a mixture of substantially round particles and non-round particles.

9. The spiral separator apparatus of claim 8, further comprising a housing substantially surrounding the separator core and arranged to be impacted by substantially round particles cast from the separator core when the separator core rotates.

10. The spiral separator apparatus of claim 8, wherein the control module is further configured to control a rotational direction of the separator core.

11. The spiral separator apparatus of claim 8, the drive means comprising a belt drive.

12. The spiral separator apparatus of claim 8, the drive means comprising a direct drive.

13. The spiral separator apparatus of claim 8, wherein the feed portion is arranged to distribute the mixture of substantially round particles and non-round particles substantially evenly among the flights of the separator core.

14. A method of separating a plurality of substantially round particles from a mixture of the substantially round particles and a plurality of non-round particles, the method comprising steps of:
energizing a motor to cause a separator core of a spiral separator apparatus to rotate about an axis, the separator core comprising a plurality of banked flights spirally disposed around a hollow shaft;
passing the mixture of substantially round particles and non-round particles through a feed portion of the separator apparatus and to the banked flights, the substantially round particles being ejected from the banked flights and impacting a housing substantially surrounding the separator core when the separator core rotates; and
collecting the substantially round particles after the substantially round particles impact the housing.

15. The method of claim 14, further comprising controlling a rotational speed of the motor.

16. The method of claim 14, further comprising controlling a rotational direction of the motor.

17. The method of claim 14, wherein the feed portion is arranged to distribute the mixture of substantially round particles and non-round particles substantially evenly among the flights of the separator core.
